(19) United States
(12) Patent Application Publication
(10) Pub. No.: US 2022/0067734 A1
(43) Pub. Date: Mar. 3, 2022

(54) SYSTEMS, METHODS, AND DEVICES FOR USER AUTHENTICATION USING CARDS WITH PRIVATE KEYS

(71) Applicant: JPMORGAN CHASE BANK, N.A., New York, NY (US)

(72) Inventors: Jeremiah C. OLVER, Middletown, DE (US); Scott H. OUELLETTE, Kingston, NH (US); Craig M. MULLANEY, Newark, DE (US)

(21) Appl. No.: 17/464,026

(22) Filed: Sep. 1, 2021

Related U.S. Application Data
(60) Provisional application No. 63/073,794, filed on Sep. 2, 2020.

(51) Int. Cl. G06Q 20/40; G06Q 20/38; G06Q 20/34; H04L 9/08

(52) U.S. Cl. CPC G06Q 20/4012; G06Q 20/40145; G06Q 20/3825; H04L 2209/56; G06Q 20/34; H04L 9/0825; G06Q 2220/00; G06Q 20/3829

(57) ABSTRACT

Systems and methods for conducting transactions using cards with keys are disclosed. In one embodiment, a method may include: receiving, at a backend for a financial institution in a transaction, a unique identifier for a card, a key read from the card by a card reading device, and additional data received by the card reading device, the card reading device associated with a merchant; retrieving, by the backend, stored additional data associated with the unique identifier; retrieving, by the backend, a stored key associated with the unique identifier in response to the received additional data matching the stored additional data; confirming, by the backend, that the received key and the stored key are related; retrieving, by the backend, a payment mechanism for the transaction; conducting, by the backend, the transaction with the retrieved payment mechanism; and settling, by the backend, the transaction with the merchant.

### RELATED APPLICATIONS

This application claims priority to, and the benefit of, U.S. Provisional Patent Application Ser. No. 63/073,794, filed Sep. 2, 2020, the disclosure of which is hereby incorporated, by reference, in its entirety.

### BACKGROUND OF THE INVENTION

### 1. Field of the Invention

Embodiments are generally directed to systems, methods, and devices for user authentication using cards with private keys.

### 2. Description of the Related Art

Many digital services leverage Public Key Infrastructure (PKI) to provide security in communication and authentication. To provision products and services to customers, however, customers are generally authenticated through the use of a username and password. This “pre-shared key” method of authentication has a number of vulnerabilities: 1) users often forget their username and/or password, forcing them the use a recovery method—such as email—which is often secured by the same method; 2) users often use simple, easy to guess passwords, and they often use the same password for many services, rendering a chain of services vulnerable is one password is compromised; 3) authenticating logins and passwords only authenticates the login credential with the service provider unable to ensure the user is the intended recipient of the services.

PKI is as set of procedures used to manage public key cryptographic pairing premised on key pairs, whereby a private key is used to authenticate a public key. Some organizations, such as the U.S. Department of Defense, use this infrastructure to authenticate users and permit access to services. This is accomplished by embedding user private certificates on smart chips built into Common Access Cards (CAC). Users are able to connect their CACs to their digital devices. When users attempt to access services with their CAC connected, the service recognizes the presence of the private certificate and users are prompted to enter a PIN that enables the authentication of the private/public certificate pairing, and the user is then granted access to the service.

### SUMMARY OF THE INVENTION

Systems, methods, and devices for user authentication using cards with private keys are disclosed. Embodiments may leverage the existing PKI by issuing financial institution customers a private key digital certificate that is embedded on the chip of bank-issued credit/debit cards, mobile devices, etc. to enable easy, secure access to services.

In one embodiment, a method for conducting transactions using cards with keys may include: (1) receiving, at a backend for a financial institution in a transaction, a unique identifier for a card, a key read from the card by a card reading device, and additional data received by the card reading device, the card reading device associated with a merchant; (2) retrieving, by the backend, stored additional data associated with the unique identifier; (3) retrieving, by the backend, a stored key associated with the unique identifier in response to the received additional data matching the stored additional data; (4) confirming, by the backend, that the received key and the stored key are related; (5) retrieving, by the backend, a payment mechanism for the transaction; (6) conducting, by the backend, the transaction with the retrieved payment mechanism; and (7) settling, by the backend, the transaction with the merchant.

In one embodiment, the card may be an identification card.

In one embodiment, the additional data may include a personal identification number or a biometric.

In one embodiment, the received key may be a private key, the stored key may be a public key, and the received key and the stored key may be related as a key pair.

In one embodiment, the step of retrieving the payment mechanism for the transaction may include applying, by the backend, at least one rule to the transaction to identify the payment mechanism.

In one embodiment, the payment mechanism may be a credit card payment, payment by reward points, etc.

According to another embodiment, a method for conducting transactions using cards with keys may include: (1) receiving, at a merchant host and from a card reading device, a unique identifier for a card, a key read from the card, additional data received by the card reading device during a transaction; (2) communicating, by the merchant host, the unique identifier, the key, and the additional data to a backend for a financial institution; (3) receiving, by the merchant host and from the backend, authorization for the transaction; (4) receiving, by the merchant host and from the backend, an encoded shipping address for the transaction, wherein the backend is configured to encode a shipping address into the encoded shipping address; and (5) providing, by the merchant host, a product associated with the transaction with the encoded shipping address to a shipping partner. The shipping partner of the financial institution may be configured to decode the encoded shipping address and deliver the product to the shipping address.

In one embodiment, the encoded shipping address may be encoded such that only the backend and the shipping partner can decode the shipping address.

In one embodiment, the shipping address may be encoded in a machine-readable code.

In one embodiment, the merchant host may affix a first label with the encoded shipping address to a package containing the product, and the shipping partner may be further configured to affix a second label with the shipping address on the package after decoding the encoded shipping address.

According to another embodiment, a method for user authentication using cards with keys may include: (1) receiving, at a backend for a financial institution, a unique identifier for a card, a key read from the card by a card reading device, and additional data received by the card reading device; (3) retrieving, by the backend, stored additional data associated with the unique identifier; (3) retrieving, by the backend, a stored key associated with the unique identifier in response to the received additional data matching the stored additional data; (4) confirming, by the backend, that the received key and the stored key are related; and (5) providing, by the backend and at a portal, access to a plurality of services.

In one embodiment, the card may be an identification card.

In one embodiment, the additional data may include a personal identification number or a biometric.

In one embodiment, the received key may be a private key, the stored key may be a public key, and the received key and the stored key may be related as a key pair.

In one embodiment, one of the plurality of services may be an account-based service for an account with the financial institution.

In one embodiment, one of the plurality of services may be an account-based service for an account with a second financial institution, wherein the second financial institution and the financial institution may be participants in a consortium.

In one embodiment, one of the plurality of services may be an identity service for a third party, wherein the backend may confirm an identity based on the stored key and the received key being related.

In one embodiment, one of the plurality of services may be an electronic signature service.

In one embodiment, the card reading device may be associated with a desktop, laptop, or tablet computer.

### BRIEF DESCRIPTION OF THE DRAWINGS

In order to facilitate a fuller understanding of the present invention, reference is now made to the attached drawings in which:

FIG. 1 discloses system for user authentication using cards with private keys according to one embodiment;

FIG. 2 discloses system for user authentication using cards with private keys according to one embodiment;

FIG. 3 discloses method for user authentication using cards with private keys according to one embodiment;

FIG. 4 discloses method for user authentication using cards with private keys according to another embodiment

### DETAILED DESCRIPTION OF PREFERRED EMBODIMENTS

Embodiments are directed to systems, methods, and devices for user authentication using a card, such as a payment card, having private keys.

Many bank-issued cards contain a smart chip that contains information that enables the processing of payments. In embodiments, this same chip may be provided with a private certificate that may be used to authenticate the user of the card when the private certificate is enabled using the user's PIN. A central certificate center may maintain the user's public certificate such that if the user's private certificate is lost (e.g., the user loses a credit/debit card), the center can issue a new public/private key pair, with the new private certificate loaded onto the replacement credit/debit card. This ensures secure access to stored materials.

In embodiments, the PKI infrastructure with a private certificate may be used to securely grant access to services, such as access to a financial institution's web portal, private and secure email (e.g., extant private/secure emails are niche offerings with most having no method to recover content when a user name or password is lost/forgotten), to make payments using the financial instrument on which the private key is stored or with another financial instrument, etc. Embodiments provide both enhanced security and increased ease-of-use as opposed to current username/password combinations.

For example, embodiments may use the PKI infrastructure at a point of sale, confirming that the user is the financial institution's customer, permitting the business to provide the product/service without the user having to identify the specific method of payment. The user can then—at a later point—determined their preferred method of payment (e.g. choose the appropriate credit card or debit the transaction directly from an account).

In another embodiment, an electronic signature service may be provided where, once authenticated, the user may digitally sign a document, and the document may be associated with the digital certificate.

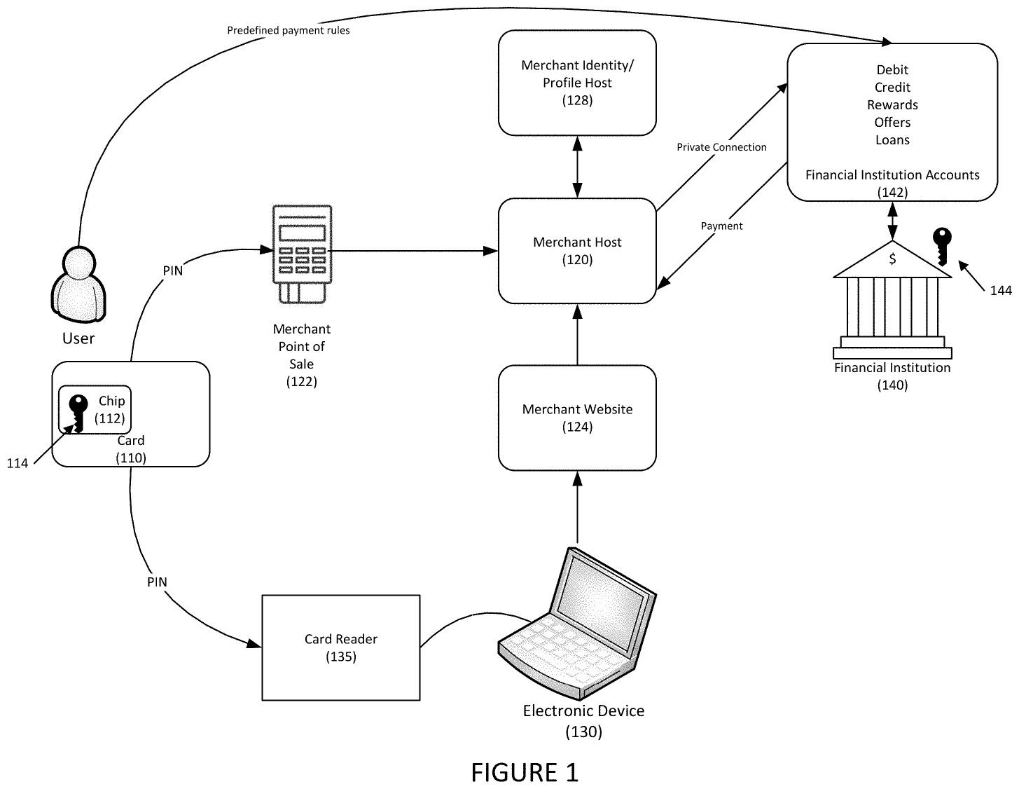

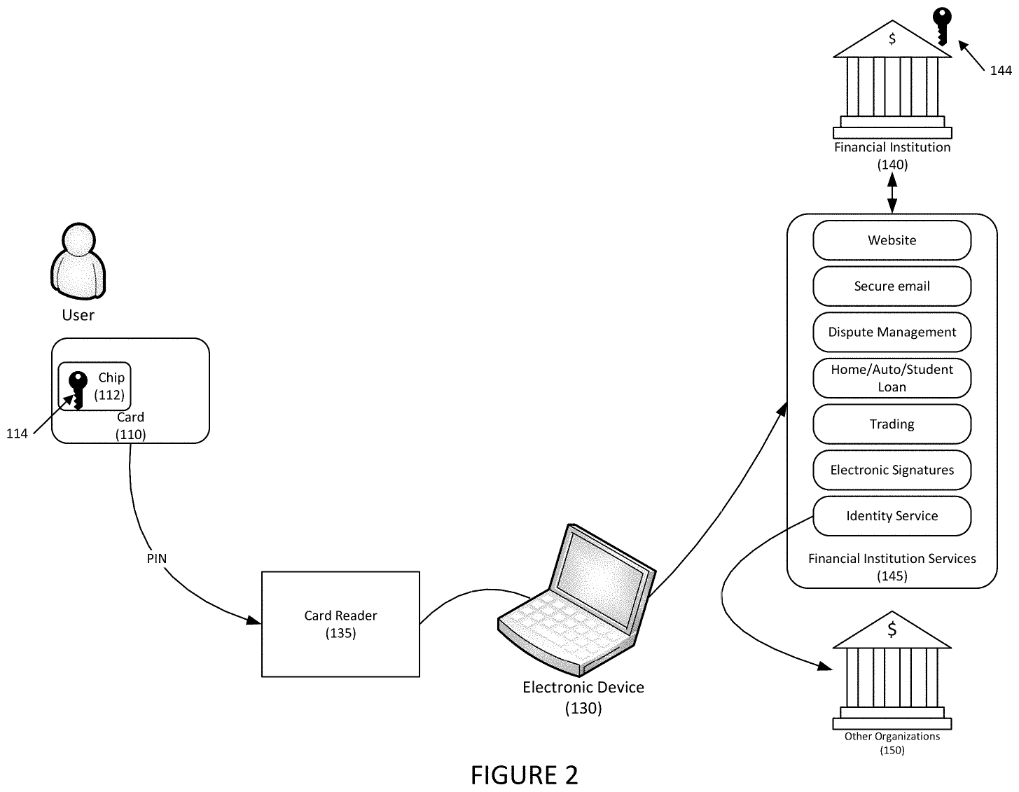

Referring to FIGS. 1 and 2, diagrams of a system for user authentication using cards having private keys is disclosed according to embodiments. Card 110, which may be a payment card, may be provided with chip 112 that may store one or more key 114 and/or an identifier. In one embodiment, card 110 may also function as a credit or debit card. In embodiments, the identifier may be a number, such as a 16-digit number, that may include a bank identification number (BIN), and may be formatted in accordance with ISO standards.

In another embodiment, card 110 may not function as a credit or debit card, but may function as an identity card. In one embodiment, the identifier stored in chip 112, may uniquely identify the holder of card 110 to financial institution 140.

In one embodiment, card 110 may be a “soft card” stored on a mobile device. Key(s) 114 may be stored on the mobile device and may be accessed via a biometric or a PIN.

In one embodiment, card 110 may be associated with financial institution. In another embodiment, card 110 may be associated with a consortium of financial institutions (not shown), and may be used to access the services provided by financial institutions that are part of the consortium.

Card 110 may be read by, for example, merchant point of sale device 122, by card reader 135 which may interface with electronic device 130, etc. Electronic device 130 may be any suitable electronic device, including computers, Internet of Things (IoT) appliances, kiosks, automated teller machines, etc.

In one embodiment, electronic device 130 may access merchant host 120 via merchant website 124.

In one embodiment, when presenting card 110, the user may enter a code, such as a PIN, or present a biometric (e.g., fingerprint, face, iris, voice, etc.).

The user may conduct a transaction at either merchant point of sale device 122 (e.g., for in person transactions) or electronic device 130 (e.g., for online transactions). After receiving key 114 and the entered code, merchant host 120 may interface with financial institution 140's financial institution accounts 142 via a private connection and may authenticate the user. Financial institution 140 may then make payment for the transaction to the merchant using one of accounts 142.

Financial institution 140 may store key 144 for the user, which may be the user's public key.

In one embodiment, financial institution 140 may use the financial instrument presented for the transaction; in another embodiment, it may apply rules defined by the user (e.g., use a debit account for grocery transactions, use a credit account for transactions over $100, user a Home Equity Line of Credit (HELOC) account for home improvement store purchases, use reward points when $50 in reward have been accumulated, etc.). The user may define the rules in any suitable manner as is necessary and/or desired.

In one embodiment, machine learning may be used to define the rules.

In one embodiment, the user may change the account for the transaction after the transaction is complete. For example, if the transaction was conducted with a debit account, and the user changes his or her mind to use a credit account, the user may change the account.

In embodiments, once the user presents card 110 and enters a code to electronic device 130, which may be the user's electronic device, the user may access services that may be provided by financial institution 140, a partner, or a third party. For example, the user may access financial institution 140's website and may be automatically authenticated to financial institution 140's online portal and access financial institution services 145. In one embodiment, financial institution services 145 may also provide access to other participating financial instructions services.

In one embodiment, one or more of the financial institution services 145 may be accessed via a portal, a website, in an application, etc.

The user may access a secure email service, where the user may be automatically logged in to the user's account. For example, the user may open a dispute management service; the user may access the user's loan accounts, such as the user's home, auto, student, HELOC, etc.; the user may access the user's trading account; the user may access a rewards portal, such as rewards associated with merchants that the user transacts with, and the user may utilize those points in the course of or subsequent to a transaction; the user may access a profile and associated privacy and security information and settings, etc.

In one embodiment, merchant identity/profile host 128 may store profiles for customers that may be retrieved after the customer is authenticated using, for example, chip 112 and a PIN entry. Once authenticated (e.g., by the identity service), the merchant will know the user, and can use that to retrieve the user's identity, profile that the user has with the merchant, etc.

The user may then interact with the merchant and may start a new order, check on an existing order, etc.

If the user starts a new order, during payment, the merchant may provide the user's identity to financial institution 140 to initiate payment to the merchant. The identifier may be use for payment without specifying a specific account for the payment. The user may then select the account for payment, or financial institution 140 may apply one or more rules to select the account. In one embodiment, the payment may be split among a plurality of accounts.

In one embodiment, the user may change the selected account(s) for a period of time after the transaction.

In another embodiment, when a transaction is conducted at merchant point of sale device 122, the user may be authenticated using, for example, chip 112 and a PIN entry, and merchant host 120 may route a payment request to financial institution 140. Similar to above, the user's identity may be used for payment, and the user may later select one or more accounts for payment, the financial institution may apply rules, etc.

Even though it is an in-person transaction at merchant point of sale device 122, merchant host 120 may retrieve the user's profile, which may allow the user to connect with the in-person shopper in similar way to how the merchant interacts with on-line shoppers. For example, merchant point of sale device 122 may be provided with information from the user profile store din merchant identity/profile host.

In embodiments, the user may access an electronic signature service. For example, one authenticated, the user may digitally sign a document using the card and key 114, and that digital signature may be affixed to, or associated with, the document. In one embodiment, an electronic document may be digitally stamped with a digital signature or other indicator.

Key 114 may be a private key for the user.

In one embodiment, the signed document may be stored in secure storage. In one embodiment, access to the secured storage may be controlled using the issued private key, whether that storage is on a local device or cloud based.

Embodiments may further provide a digital identity service for third parties, such as other organizations 150, including other financial institutions, merchants, etc. For example, other organization 150 may request authentication of the user by financial institution 140, and the user may present card 110 and enter a code (e.g., a PIN) at the third party (e.g., electronic device 130) and have his or her identity verified by financial institution 140.

In another embodiment, the certificate may be used to authenticate users and provision personal information to external entities in exchange for goods and services. Such external entities may include digital as well as physical entities. A record of the data provided may be retained in secured storage with access control managed by the private certificate. The user can, in applicable jurisdictions, leverage the user's data subject access rights (DSAR) to generate requests to some or all of the recipient entities to delete the user's data. These requests can be digitally signed using the financial institution-issued certificate, obviating the need for the external entity to authenticate the user.

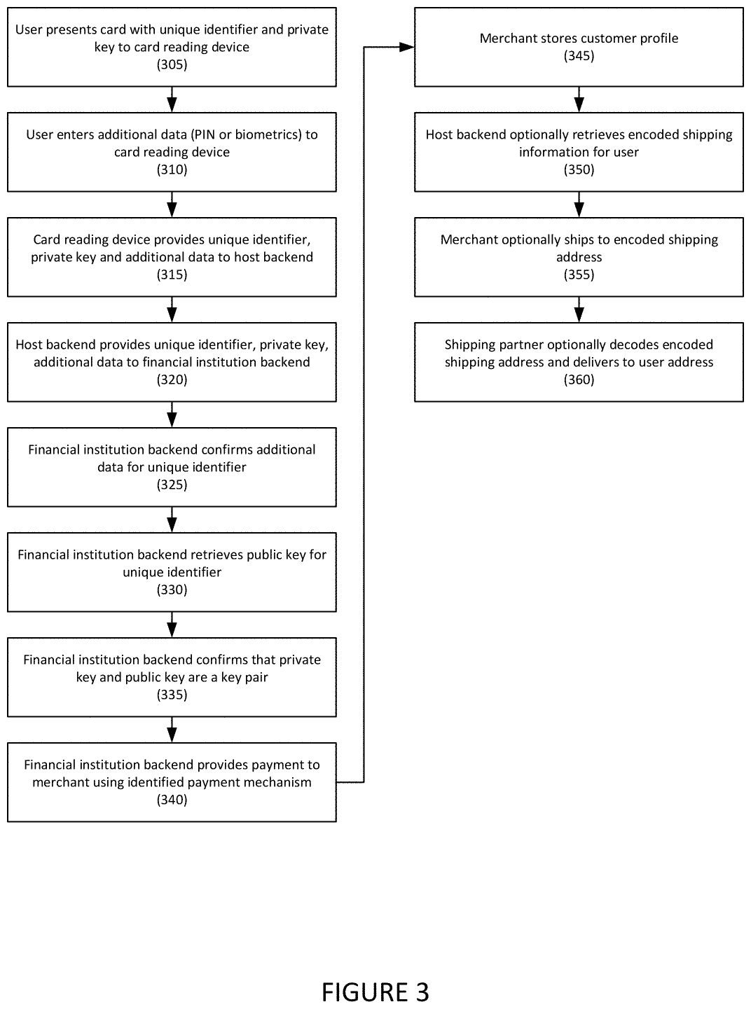

Referring to FIG. 3, a method for conducting transactions using cards with keys is provide according to an embodiment.

In step 305, a user may present a card having a unique identifier and a key stored thereon, such as a private key, to a card reading device. The card reading device may be at a point of sale device, at an electronic device, etc. The card reading device may read the unique identifier and the key from the card.

In one embodiment, the user may present the card to the card reading device as part of conducting a transaction, such as during a payment step.

In step 310, the user may enter additional data at the card reading device, an electronic device associated therewith, etc. The additional data may be a personal identification number (PIN), a biometric, etc.

In step 315, the card reading device may provide the unique identifier, the private key, and the additional data to a host backend.

In step 320, the host backend may provide the unique identifier, the key, and the additional data to a financial institution backend.

In step 325, the financial institution backend may retrieve stored additional data for the unique identifier and may confirm that the additional data received from the host backend matches the stored additional data. For example, the financial institution backend may retrieve the stored additional data from a database.

In step 330, the financial institution backend may retrieve a stored key, such as a public key, for the unique identifier. For example, the financial institution backend may retrieve the stored key from a database.

In step 335, the financial institution backend may confirm that the stored key and the key received from host backend are related. For example, the financial institution backend may confirm that the keys have a relationship, such as a key pair relationship (e.g., public key-private key).

In step 340, the financial institution backend may provide payment to the merchant using an identified payment mechanism. For example, the financial institution backend may identify a payment mechanism specified by the user, may apply one or more rules to optimize selection of the payment mechanism (e.g., select the payment mechanism that provides the maximum benefits (e.g., loyalty or reward points, incentives, etc.), etc.

In step 345, the merchant may retrieve a profile for the user after the user is authenticated (e.g., in step 325). Once authenticated, the merchant “knows” the user, and may use that knowledge to retrieve a profile that the user has with the merchant. The profile may include, for example, the user's shopping history, order status, shipping preferences, addresses, etc.

In optional step 350, the host backend may retrieve encoded shipping information for the user. For example, the host backend may retrieve the user's preferred shipping information and may encrypt or encode the shipping information. It may then provide the encoded shipping information to the merchant.

The encoded shipping information may be a bar code, QR code, an alphanumeric code, etc.

In optional step 355, the merchant may ship the purchase to the encoded shipping information. For example, the merchant may affix a label with the encoded shipping information to a package, and may provide the package to a shipping partner.

In optional step 360, the shipping partner may decode the encoded shipping information and may deliver the purchase to the user address. For example, the shipping partner may decode the encoded shipping information using an electronic device and may affix a new label to the package, or the decoded shipping information may only be displayed in the shipping partner's electronic device. Thus, the user address is not affixed to the package.

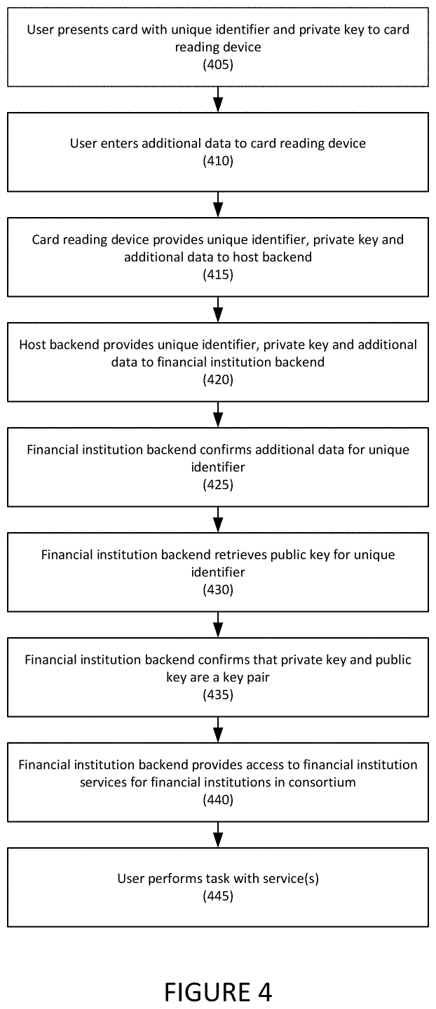

Referring to FIG. 4, a method for user authentication using cards with private keys according to another embodiment.

In step 405, a user may present a card having a unique identifier and a key stored thereon, such as a private key, to a card reading device. In one embodiment, the card reading device may be a point of sale device, an electronic device associated with a computer, a terminal, a kiosk, etc.

In one embodiment, the user may present the card to the card reading device in order to access account information for an account with a financial institution, to access additional services provided by a financial institution, etc. Examples may include secure access to a financial institution's website, access to secure email, access to a dispute management system, access to financial information (e.g., loan information), access to trading platform, access to an electronic signature platform, access to an identify service (e.g., confirm the user's identity to another entity), etc.

In step 410, the user may enter additional data at the card reading device, an electronic device associated therewith, etc. The additional data may be a personal identification number (PIN), a biometric, etc.

In step 415, the card reading device may provide the unique identifier, the private key, and the additional data to a host backend.

In step 420, the host backend may provide the unique identifier, the key, and the additional data to a financial institution backend.

In step 425, the financial institution backend may retrieve stored additional data for the unique identifier and may confirm that the additional data received from the host backend matches the stored additional data. For example, the financial institution backend may retrieve the stored additional data from a database.

In step 430, the financial institution backend may retrieve a stored key, such as a public key, for the unique identifier. For example, the financial institution backend may retrieve the stored key from a database.

In step 435, the financial institution backend may confirm that the stored key and the key received from host backend are related. For example, the financial institution backend may confirm that the keys have a relationship, such as a public key-private key relationship.

In step 440, the financial institution backend may then provide access to financial institution services for the financial institution, or to other financial institutions that may participate in a consortium.

In step 445, the user may perform one or more task using the services.

Thus, embodiments provide access to the user's financial accounts, as well as to other services that may be provided by the financial institution, other financial institutions in the consortium, etc. by presenting the card and additional data, and not logging into a website or application for the financial institution using, for example, username and password. In addition, the financial institution backend may verify the identity of the user to other entities, such as other financial institutions, merchants, government agencies, transaction partners, etc.

Although multiple embodiments have been disclosed, it should be recognized that these embodiments are not mutually exclusive and features from one embodiment may be used with others.

Hereinafter, general aspects of implementation of the systems and methods of the invention will be described.

The system of the invention or portions of the system of the invention may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for conducting transactions using cards with keys, comprising:
receiving, at a backend for a financial institution in a transaction, a unique identifier for a card, a key read from the card by a card reading device, and additional data received by the card reading device, the card reading device associated with a merchant;
retrieving, by the backend, stored additional data associated with the unique identifier;
retrieving, by the backend, a stored key associated with the unique identifier in response to the received additional data matching the stored additional data;
confirming, by the backend, that the received key and the stored key are related;
retrieving, by the backend, a payment mechanism for the transaction;
conducting, by the backend, the transaction with the retrieved payment mechanism; and
settling, by the backend, the transaction with the merchant.

2. The method of claim 1, wherein the card is an identification card.

3. The method of claim 1, wherein the additional data comprises a personal identification number or a biometric.

4. The method of claim 1, wherein the received key is a private key, the stored key is a public key, and the received key and the stored key are related as a key pair.

5. The method of claim 1, wherein the step of retrieving the payment mechanism for the transaction comprises:
applying, by the backend, at least one rule to the transaction to identify the payment mechanism.

6. The method of claim 1, wherein the payment mechanism comprises a credit card payment.

7. The method of claim 1, wherein the payment mechanism comprises payment by reward points.

8. A method for conducting transactions using cards with keys, comprising:
receiving, at a merchant host and from a card reading device, a unique identifier for a card, a key read from the card, additional data received by the card reading device during a transaction;
communicating, by the merchant host, the unique identifier, the key, and the additional data to a backend for a financial institution;
receiving, by the merchant host and from the backend, authorization for the transaction;
receiving, by the merchant host and from the backend, an encoded shipping address for the transaction, wherein the backend is configured to encode a shipping address into the encoded shipping address; and
providing, by the merchant host, a product associated with the transaction with the encoded shipping address to a shipping partner;
wherein the shipping partner of the financial institution is configured to decode the encoded shipping address and deliver the product to the shipping address.

9. The method of claim 8, wherein the encoded shipping address is encoded such that only the backend and the shipping partner can decode the shipping address.

10. The method of claim 8, wherein the shipping address is encoded in a machine-readable code.

11. The method of claim 8, wherein the merchant host affixes a first label with the encoded shipping address to a package containing the product, and the shipping partner is further configured to affix a second label with the shipping address on the package after decoding the encoded shipping address.

12. A method for user authentication using cards with keys, comprising:
receiving, at a backend for a financial institution, a unique identifier for a card, a key read from the card by a card reading device, and additional data received by the card reading device;
retrieving, by the backend, stored additional data associated with the unique identifier;
retrieving, by the backend, a stored key associated with the unique identifier in response to the received additional data matching the stored additional data;
confirming, by the backend, that the received key and the stored key are related; and
providing, by the backend and at a portal, access to a plurality of services.

13. The method of claim 12, wherein the card is an identification card.

14. The method of claim 12, wherein the additional data comprises a personal identification number or a biometric.

15. The method of claim 13, wherein the received key is a private key, the stored key is a public key, and the received key and the stored key are related as a key pair.

16. The method of claim 13, wherein one of the plurality of services comprises an account-based service for an account with the financial institution.

17. The method of claim 13, wherein one of the plurality of services comprises an account-based service for an account with a second financial institution, wherein the second financial institution and the financial institution are participants in a consortium.

18. The method of claim 13, wherein one of the plurality of services comprises an identity service for a third party, wherein the backend confirms an identity based on the stored key and the received key being related.

19. The method of claim 13, wherein one of the plurality of services comprises an electronic signature service.

20. The method of claim 13, wherein the card reading device is associated with a desktop, laptop, or tablet computer.
